(19) United States
(12) Patent Application Publication
(10) Pub. No.: US 2017/0302848 A1
(43) Pub. Date: Oct. 19, 2017

(54) PHOTOGRAPHING METHOD, DEVICE AND COMPUTER STORAGE MEDIUM

(71) Applicant: NUBIA TECHNOLOGY CO., LTD., Shenzhen, Guangdong (CN)

(72) Inventors: Qiang WEI, Guangdong (CN); Qiang LI, Guangdong (CN)

(73) Assignee: NUBIA TECHNOLOGY CO., LTD., Shenzhen, Guangdong (CN)

(21) Appl. No.: 15/513,626

(22) PCT Filed: Aug. 6, 2015
(86) PCT No.: PCT/CN2015/086237

§ 371 Date: Mar. 23, 2017

(30) Foreign Application Priority Data
Sep. 23, 2014 (CN) 201410490675.9

(51) Int. Cl. H04N 5/232; G06F 3/0484; G06F 3/0488

(52) U.S. Cl. CPC H04N 5/23216; H04N 5/23293; G06F 3/04842; G06F 3/04845; G06F 3/0488; G06F 3/04847

(57) ABSTRACT

A photographing method and device are disclosed. The photographing method includes the steps: dividing a photosensitive area of a photosensitive element into at least two subareas; adjusting photosensitive parameters of at least one subarea; and performing photographing according to photosensitive parameters of each subarea of the photosensitive element. In the technical scheme of the present disclosure, by dividing the photosensitive area of the photosensitive element into a plurality of subareas, each subarea may be controlled independently, and especially photosensitive parameters of each subarea may be adjusted respectively, it is equivalent to a controllable optical filter, which is based on to perform photographing according to the photosensitive parameters of each subarea of the photosensitive element, so that a photograph obtained by photographing has a brighter color, richer details and a clearer image, which enhances the photographing effect and improves the user experience.

### TECHNICAL FIELD

The present document relates to the field of photographing technology, and in particular, to a photographing method and device.

### BACKGROUND OF THE RELATED ART

The photographing device in the related art allows a user to adjust photosensitive parameters of a photosensitive element, so as to shoot a photograph with better effects. However, only the entire photosensitive element may be adjusted in the related art, but specific conditions of each area of the image are different, and it is apparent that the same parameter cannot be applicable to all areas, thus the overall effect of the shot photograph is bad, and the user experience is not good.

### CONTENT OF THE INVENTION

The main object of the present invention is to provide a photographing method and device, which is intended to enhance the photographing effect and improve the user experience.

In order to achieve the above object, the following technical scheme is adopted.

A photographing method includes steps:

dividing a photosensitive area of a photosensitive element into at least two subareas;

adjusting photosensitive parameters of at least one subarea; and

performing photographing according to photosensitive parameters of the at least two subareas of the photosensitive element after the photosensitive parameters are adjusted.

Alternatively, the step of adjusting photosensitive parameters of at least one subarea includes:

displaying all subareas of the photosensitive area;

selecting subareas, and acquiring required photosensitive parameters; and

adjusting photosensitive parameters of the selected subareas to the required photosensitive parameters acquired.

Alternatively, the step of adjusting photosensitive parameters of at least one subarea includes:

displaying a preview image of a photographed scenery;

selecting an adjustment area on the preview image;

determining subareas of the photosensitive area corresponding to the adjustment area, and acquiring required photosensitive parameters; and

adjusting photosensitive parameters of the subareas corresponding to the adjustment area to the required photosensitive parameters acquired.

Alternatively, after the step of adjusting photosensitive parameters of the subareas corresponding to the adjustment area to the required photosensitive parameters acquired, the method further includes:

regenerating a preview image according to the adjusted photosensitive parameters and displaying the preview image.

Alternatively, the photosensitive parameters include: any one or more of exposure time, white balance and photosensibility.

A photographing device includes a setting module, an adjustment module and a photographing module, herein:

the setting module is arranged to: divide a photosensitive area of a photosensitive element into at least two subareas;

the adjustment module is arranged to: adjust photosensitive parameters of at least one subarea; and

the photographing module is arranged to: perform photographing according to photosensitive parameters of the at least two subareas of the photosensitive element after the photosensitive parameters are adjusted.

Alternatively, the device further includes a display module, herein,

the display module is arranged to: display all subareas of the photosensitive area;

the adjustment module is arranged to adjust photosensitive parameters of at least one subarea by means of: selecting subareas, and acquiring required photosensitive parameters, and adjusting photosensitive parameters of the selected subareas to the required photosensitive parameters acquired.

Alternatively, the device further includes a display module, herein,

the photographing module is arranged to: generate a preview image of a photographed scenery;

the display module is arranged to: display the preview image; and

the adjustment module is arranged to adjust photosensitive parameters of at least one subarea by means of: selecting an adjustment area on the preview image; determining subareas of the photosensitive area corresponding to the adjustment area, and acquiring required photosensitive parameters; and adjusting photosensitive parameters of the subareas corresponding to the adjustment area to the required photosensitive parameters acquired.

Alternatively, the photographing module is further arranged to: regenerate a preview image according to the adjusted photosensitive parameters;

the display module is further arranged to: display the regenerated preview image.

Alternatively, the photosensitive parameters include: any one or more of exposure time, white balance and photosensibility.

Alternatively, the device further includes a photosensitive element.

A computer program includes a program instruction, herein, when the program instruction is executed by a computer, the computer may execute the above any photographing method.

A carrier carrying the computer program.

With a photographing method of the technical scheme of the present invention, by dividing a photosensitive area of a photosensitive element into a plurality of subareas, each subarea may be controlled independently, and especially photosensitive parameters of each subarea may be adjusted respectively, it is equivalent to a controllable optical filter, which is based on to perform photographing according to the photosensitive parameters of each subarea of the photosensitive element, so that a photograph obtained by photographing has a brighter color, richer details and a clearer image, which enhances the photographing effect and improves the user experience.

### BRIEF DESCRIPTION OF DRAWINGS

FIG. 1 is a flow chart of a photographing method according to an embodiment 1 of the present invention;

FIG. 2 is a flow chart of a photographing method according to an embodiment 2 of the present invention;

FIG. 3 is a schematic diagram of modules of a photographing device according to an embodiment of the present invention; and

FIG. 4 is a schematic diagram of an electrical structure of a photographing device provided in an embodiment of the present invention.

The implementation of the object, functional characteristics and advantages of the present invention will be further described in combination with the embodiments and with reference to the accompanying drawings.

### PREFERRED EMBODIMENTS OF THE PRESENT INVENTION

It should be understood that the specific embodiments described here are only used to explain the present invention, which is not used to limit the present invention.

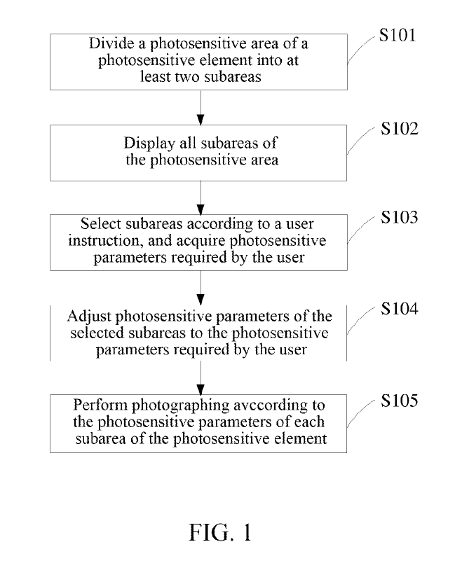

With reference to FIG. 1, a photographing method according to an embodiment 1 of the present invention is disclosed, and the photographing method includes the following steps.

In step S101, divide a photosensitive area of a photosensitive element into at least two subareas.

The photosensitive element may be a Complementary Metal Oxide Semiconductor (CMOS) and a Charge Coupled Device (CCD) and so on. The purpose of dividing the photosensitive area of the photosensitive element into subareas is to make it convenient for independently controlling photosensitive parameters of each area of the photosensitive element, the more the divided subareas are, the stronger controllability to the photosensitive element is.

In step S102, display all subareas of the photosensitive area.

A user may enter a setup menu to adjust photosensitive parameters of each subarea before or after opening a camera application, or may trigger a function of adjusting photosensitive parameters according to a preset operation instruction such as touching, clicking a preset location or pressing a preset function key after opening the camera application. The photographing device then displays an adjustment interface and displays all the subareas of the photosensitive area on the screen.

In step S103, select subareas according to a user instruction, and acquire photosensitive parameters required by the user.

The user may select corresponding subareas by clicking or touching the screen, and after the subareas are selected, an input interface or an adjustment interface for the photosensitive parameters is immediately displayed in photographing for the user to choose or input the required photosensitive parameters, and the photosensitive parameters selected or input by the user are acquired. The photosensitive parameters may be one or any combination of exposure time, white balance and photosensibility (ISO) and so on. Herein, the exposure time may be used for adjusting luminance, the white balance may be used for adjusting color cast, and the photosensibility may be used for adjusting light sensitivity.

In step S104, adjust the photosensitive parameters of the selected subareas to the photosensitive parameters required by the user.

The user may also adjust other subareas after adjusting photosensitive parameters of one subarea, so as to implement custom settings on the photosensitive parameters of each subarea respectively.

In step S105, perform photographing according to the photosensitive parameters of each subarea of the photosensitive element.

Specifically, when a photographing key is triggered, the photographing device collects image data, and exposures various parts of the image data respectively according to the photosensitive parameters of each subarea of the photosensitive element, and eventually generates a photograph. Since the photosensitive parameters of each subarea of the photosensitive element are adjusted respectively, the generated photograph has a brighter color, richer details and a clearer image.

For example, the photosensitive element is divided into a plurality of subareas from top to bottom, the exposure time of each subarea is adjusted, the exposure time is increased gradually from top to bottom, so that the luminance of the shot photograph is increased gradually from top to bottom. Or, the photosensitive element is divided into a plurality of subareas from left to right, the white balance of each subarea is adjusted, the white balance is increased gradually from left to right, so that the color cast of the shot photograph is changed gradually from left to right. Adjustments can also be performed regarding to the specific conditions of each area respectively, if the left light of the scenery is stronger, the exposure time of the corresponding subareas of the photosensitive element may be shortened to avoid overexposure, and if the right tone of the scenery is cooler, the white balance of the corresponding subareas of the photosensitive element may be adjusted to warm the tone. Moreover, a combination of any two of the photosensitive parameters like exposure time, white balance and photosensibility may also be adjusted, or a combination of any multiple kinds may be adjusted, in a word, the user may shoot a photograph with various effects according to his/her own individualization needs, which enhances the photographing effect and satisfies the user's individualization needs.

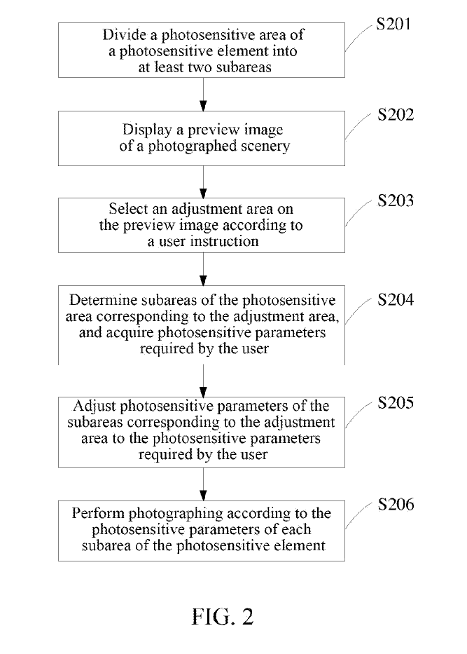

With reference to FIG. 2, a photographing method according to an embodiment 2 of the present invention is disclosed, and the photographing method includes the following steps.

In step S201, divide a photosensitive area of a photosensitive element into at least two subareas.

In step S202, display a preview image of a photographed scenery.

The embodiment allows the user to adjust the photosensitive parameters in a photographing process or after opening a camera application, and the photographing device generates the preview image of the photographed scenery at this point and displays the preview image on the screen.

In step S203, select an adjustment area on the preview image according to a user instruction.

The user may directly touch or click a certain location of the preview image, and the photographing device selects the location as the adjustment area.

In step S204, determine subareas of the photosensitive area corresponding to the adjustment area, and acquire photosensitive parameters required by the user.

Various areas on the screen and various subareas of the photosensitive element are in one-to-one correspondence, the photographing device determines the corresponding subareas according to the adjustment area selected by the user on the screen. Meanwhile, the photosensitive parameters input or selected by the user are acquired.

In step S205, adjust photosensitive parameters of the subareas corresponding to the adjustment area to the photosensitive parameters required by the user.

The user may also adjust other subareas after adjusting photosensitive parameters of one subarea, so as to implement custom settings on the photosensitive parameters of each subarea respectively.

Alternatively, after the adjustment on photosensitive parameters of one subarea is completed, a preview image is immediately regenerated according to the adjusted photosensitive parameters and is displayed, so that the user may check the image effect in real time to decide whether it is required to continue the adjustment.

In step S206, perform photographing according to the photosensitive parameters of each subarea of the photosensitive element.

The embodiment allows the user to select the adjustment area on the preview image for performing photosensitive parameter adjustment, so that the adjustment process is more visualized, the image effect after the adjustment may be checked in real time, so that the user may rapidly create satisfying works.

In certain embodiments, the photographing device may also automatically adjust the photosensitive parameters of each area of the photosensitive element according to the preset rules or conditions.

Therefore, with the photographing method of the present invention, by dividing the photosensitive area of the photosensitive element into a plurality of subareas, each subarea may be controlled independently, and especially photosensitive parameters of each subarea may be adjusted respectively, it is equivalent to a controllable optical filter, and photographing is performed according to the photosensitive parameters of each subarea of the photosensitive element, so that a photograph obtained by photographing has a brighter color, richer details and a clearer image, which enhances the photographing effect and improves the user experience.

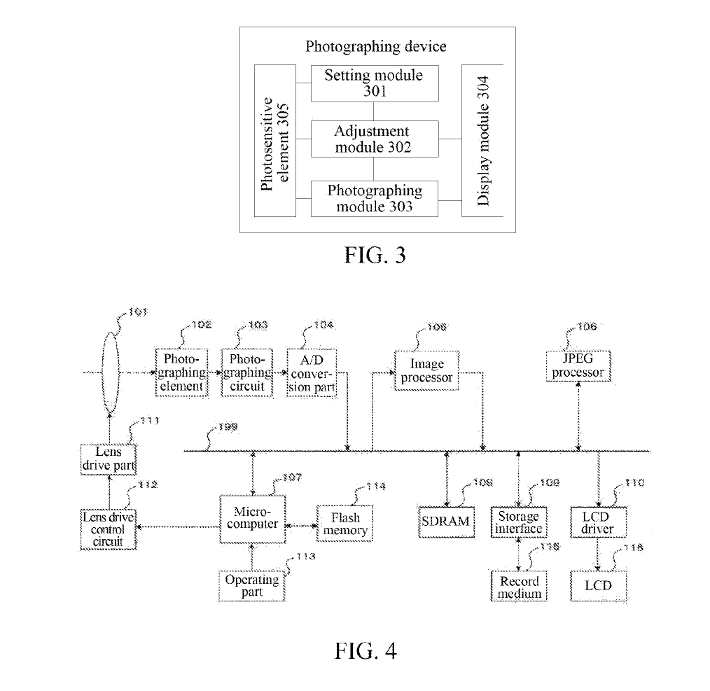

With reference to FIG. 3, a photographing device according to an embodiment of the present invention is disclosed, and the photographing device includes a setting module 301, an adjustment module 302, a photographing module 303 and a display module 304, the photosensitive element may be a Complementary Metal Oxide Semiconductor (CMOS) and a Charge Coupled Device (CCD) and so on.

The setting module 301 is arranged to: divide a photosensitive area of a photosensitive element into at least two subareas.

The purpose of dividing the photosensitive area of the photosensitive element into subareas is to make it convenient for independently controlling photosensitive parameters of each subarea of the photosensitive element, the more the divided subareas are, the stronger controllability to the photosensitive element is.

The adjustment module 302 is arranged to: adjust photosensitive parameters of at least one subarea. The photosensitive parameters may be one or any combination of exposure time, white balance and photosensibility (ISO) and so on. Herein, the exposure time may be used for adjusting luminance, the white balance may be used for adjusting color cast, and the photosensibility may be used for adjusting light sensitivity.

In certain embodiments, the adjustment module 302 displays all subareas of the photosensitive area on the screen via the display module after receiving a photosensitive parameter adjustment instruction, then selects subareas according to a user instruction, and acquires photosensitive parameters required by the user, and finally adjusts photosensitive parameters of the selected subareas to the photosensitive parameters required by the user. The user may also adjust other subareas after adjusting photosensitive parameters of one subarea, so as to implement custom settings on the photosensitive parameters of each subarea respectively.

In some other embodiments, in a photographing process or after starting a camera application, the adjustment module 302 receives a photosensitive parameter adjustment instruction, selects an adjustment area on a preview image generated by the photographing module according to the user instruction, then determines subareas of the photosensitive area corresponding to the adjustment area, and acquires photosensitive parameters required by the user, and finally adjusts photosensitive parameters of the subareas corresponding to the adjustment area to the photosensitive parameters required by the user.

Alternatively, the adjustment module 302 may also automatically adjust the photosensitive parameters of each area of the photosensitive element according to the preset rules or conditions.

The photographing module 303 is arranged to: generate a preview image of photographed scenery and display the preview image via the display module, and perform photographing according to photosensitive parameters of each subarea of the photosensitive element. Specifically, when a photographing key is triggered, the photographing device collects image data, and exposures various parts of the image data respectively according to the photosensitive parameters of each subarea of the photosensitive element, and eventually generates a photograph.

Alternatively, after the adjustment module 302 adjusts photosensitive parameters of a certain subarea, the photographing module 303 regenerates a preview image according to the adjusted photosensitive parameters and displays the preview image via the display module, so that the user may check the image effect in real time to decide whether it is required to continue the adjustment.

Alternatively, the photographing device also includes a photosensitive element 305.

The embodiment of the present invention also discloses a computer program including a program instruction, which, when the program instruction is executed by a computer, enable the computer to execute the above any photographing method.

The embodiment of the present invention also discloses a carrier carrying the computer program.

Hereby, the photographing device of the present invention divides the photosensitive area of the photosensitive element into a plurality of subareas via the setting module, so that the adjustment module may control each subarea independently and especially adjust photosensitive parameters of each subarea respectively, it is equivalent to a controllable optical filter, and the photographing module performs photographing according to the photosensitive parameters of each subarea of the photosensitive element, so that a photograph obtained by photographing has a brighter color, richer details and a clearer image, which enhances the photographing effect and improves the user experience.

It should be noted that illustration is only made through the division of the above various function modules when the photographing device provided in the above embodiment performs photographing, in practical applications, the above function allocations may be completed by different function modules according to the needs. In addition, the photographing device provided in the above embodiment and the photographing method embodiment belong to the same conception, for details see the method embodiment for a specific implementation process thereof, and all the technical characteristics in the method embodiment are accordingly applicable to the device embodiment, which will not be repeated here.

The ordinary person skilled in the art can understand that all or part of steps for implementing the above method embodiments may be completed by a program controlling related hardware, the program may be stored in a computer readable memory medium, and the memory medium may be a ROM/RAM, magnetic disk or optical disk and so on.

The embodiment of the present invention also provides a computer memory medium, the computer memory medium stores a computer executable instruction, and the computer executable instruction is used for at least one of the above methods for photographing a star-track video, specifically the methods as shown in FIG. 1 and/or FIG. 2 and/or FIG. 3.

The computer memory medium may be memory mediums of various types such as a ROM/RAM, magnetic disk, optical disk, DVD or U disk and the like, and the computer memory medium of the embodiment may be selected as a non-instant memory medium.

It should be noted that, in the photographing device in the embodiments of the present application, the setting module 301 and the adjustment module 302 may be executed by dedicated processors of various types with the information processing function or be executed by a microcomputer in a camera as described below, the photographing module 303 and the display module 304 may be executed by the camera as described below, or the photographing module 303 is executed by the camera as described below and the display module 304 is executed by a dedicated displayer. The processors may include information processing structures or chips such as an Application Processor (AP), a Central Processing Unit (CPU), a Digital Signal Processor (DSP) or a Field Programmable Gate Array (FPGA) and so on, and the processors may implement the above functions by executing specified codes.

FIG. 4 is a block diagram representing a main electrical structure of a camera according to an embodiment of the present invention, herein:

A photographic lens 101 is constructed by a plurality of optical lenses used for forming a photographed body image, and it is a monofocal lens or a zoom lens. The photographic lens 101 may move in a direction of optical axis through a lens drive part 111, a focal position of the photographic lens 101 is controlled according to a control signal from a lens drive control part 112 or a lens drive control circuit 112, and a focal distance is also controlled in the case of zoom lens. The lens drive control circuit 112 performs drive control on the lens drive part 111 according to a control command from a microcomputer 107.

A photographing element 102 is configured near the location of the photographed body image formed by the photographic lens 101 and on the optical axis of the photographic lens 101. The photographing element 102 is arranged to: photograph the photographed body image and obtain photographed image data. Photodiodes forming various pixels are configured two-dimensionally in a matrix shape on the photographing element 102. Each photodiode generates photovoltaic conversion current corresponding to absorbed dose of light, and charge accumulation is performed on the photovoltaic conversion current by a capacitor connected to each photodiode. RGB color filters arrayed by Bayer are configured on the front surface of each pixel.

The photographing element 102 is connected to a photographing circuit 103, the photographing circuit 103 performs charge accumulation control and image signal reading control in the photographing element 102, and performs wave shaping after reducing and resetting noise for the read image signal (an analog image signal), and then performs gain enhancement and so on to make it become an appropriate signal level.

The photographing circuit 103 is connected to an A/D conversion part 104, the A/D conversion part 104 performs analog-to-digital conversion on the analog image signal and outputs a digital image signal (hereinafter called image data) to a bus 199.

The bus 199 is a transmission path used for transmitting various data read or generated in the camera. The bus 199 is connected to the above A/D conversion part 104 as well as an image processor 105, a JPEG processor 106, the microcomputer 107, a Synchronous DRAM (SDRAM) 108, a storage interface (hereinafter called storage I/F) 109 and a Liquid Crystal Display (LCD) driver 110.

The image processor 105 performs various image processing including OB subtraction processing, white balance adjustment, color matrix operations, gamma conversion, color difference signal processing, denoising processing, synchronization processing and edge processing and the like on the image data output based on the photographing element 102.

The compression and decompression processor 106 compresses the image data read from the SDRAM108 according to the JPEG compression mode when recording the image data in a record medium 115. In addition, the JPEG processor 106 decompresses the JPEG image data in order to perform image reproduction display. When it is to perform decompression, files recorded in the record medium 115 are read, and after the decompression processing is implemented in the JPEG processor 106, the decompressed image data are temporarily stored in the SDRAM108 and displayed on an LCD116. Moreover, in the embodiment, the image compression and decompression mode uses the JPEG mode, but the compression and decompression mode is not limited to this, and it may certainly use other compression and decompression modes such as MPEG, TIFF and H.264 and the like.

An operating unit 113 or an operating part 113 includes but is not limited to an entity key or a virtual key, the entity key or virtual key may be operating components including various enter buttons such as a power button, a photographing key, an edit key, a dynamic image button, a reproduction button, a menu button, a cross key, an OK button, a delete button and a large button and various enter keys, and operating states of the operating components are detected.

A detection result is output to the microcomputer 107. Moreover, the front surface of the LCD116 as the display part is provided with a touch panel to detect a touch location of the user, and the touch location is output to the microcomputer 107. The microcomputer 107 executes various processing corresponding to the user's operations according to a detection result from the operating components of the operating unit 113. Or, the microcomputer 107 executes various processing corresponding to the user's operations according to a detection result of the touch panel on the front surface of the LCD116.

A flash memory 114 stores a program used for executing various processing sequences of the microcomputer 107. The microcomputer 107 performs overall control on the camera according to the program. Moreover, the flash memory 114 stores various adjustment values of the camera, the microcomputer 107 reads an adjustment value and controls the camera according to the adjustment value. The SDRAM108 is an electrically-alterable volatile memory used for temporarily storing the image data. The SDRAM108 is arranged to temporarily store the image data output from the A/D conversion part 104 and the image data processed in the image processor 105 and the JPEG processor 106 and so on.

The microcomputer 107 as an overall control part of the camera uniformly controls various processing sequences of the camera. The microcomputer 107 is connected to the operating unit 113 and the flash memory 114.

The microcomputer 107 may control the device in the embodiment by executing the program to execute the following operations: collecting one image every other preset time by the camera after the photographing is started;

performing picture synthesis on the current image and the previous image, and generating a synthetic image;

capturing the synthetic image, and performing encoding processing on the captured synthetic image; and

making the encoded and processed image data into a video file when the photographing is finished.

Alternatively, performing picture synthesis on the current image and the previous image includes:

performing picture synthesis according to luminance information of the current image and the previous image.

Alternatively, performing picture synthesis according to luminance information of the current image and the previous image includes: judging whether the luminance of pixels in the current image is greater than the luminance of pixels in the previous image in the same location; if the luminance of pixels in the current image is greater than the luminance of pixels in the previous image, replacing the pixels in the previous image with the pixels in the current image in the same location, and performing picture synthesis based on this.

Alternatively, the camera is a front-facing camera, after the step of collecting one image every other preset time by the camera, it also includes: performing mirroring processing on the image.

Alternatively, before the step of performing encoding processing on the captured synthetic image, it also includes: performing special effect processing on the captured synthetic image, the special effect processing includes basic effect processing, filter effect processing and/or special scene effect processing.

The storage interface 109 is connected to the record medium 115, and performs control of writing image data and data like a file header attached in the image data into the record medium 115 and reading them from the record medium 115. The record medium 115 is record mediums such as a storage card that can be freely disassembled and assembled on the camera body, but it is not limited to this, it may also be a hard disk built in the camera body.

The LCD driver 110 is connected to the LCD116, and stores the image data processed by the image processor 105 in the SDRAM, when it is required to display, reads the image data stored in the SDRAM and displays the image data on the LCD116, or, the image data compressed by the JPEG processor 106 are stored in the SDRAM, when it is required to display, the JPEG processor 106 reads the compressed image data in the SDRAM, then performs decompression, and displays the decompressed image data via the LCD116.

The LCD116 is configured on the reverse side of the camera body to display the image. The LCD116 is provided with a touch panel for detecting a touch operation of the user. In addition, a liquid crystal display panel (LCD116) is configured as the display part in the embodiment, but it is not limited to this, various display panels such as organic EL may also be used.

It should be understood that the above description is only the preferred embodiments of the present invention, which cannot limit the patent scope of the present invention due to this. Equivalent structures or equivalent flow transformations made by using the contents of descriptions and accompanying drawings of the present invention, or directly or indirectly application of the contents of descriptions and accompanying drawings of the present invention other related technical fields, are all included in the patent protection scope of the present invention similarly.

### INDUSTRIAL APPLICABILITY

With a photographing method of the technical scheme of the present invention, by dividing a photosensitive area of a photosensitive element into a plurality of subareas, each subarea may be controlled independently, and especially photosensitive parameters of each subarea may be adjusted respectively, it is equivalent to a controllable optical filter, and photographing is performed according to the photosensitive parameters of each subarea of the photosensitive element, so that a photograph obtained by photographing has a brighter color, richer details and a clearer image, which enhances the photographing effect and improves the user experience. Therefore, the present invention has very strong industrial applicability.

What we claim is:

1. A photographing method, comprising steps of:
dividing a photosensitive area of a photosensitive element into at least two subareas;
adjusting photosensitive parameters of at least one subarea; and
performing photographing according to photosensitive parameters of the at least two subareas of the photosensitive element after the photosensitive parameters are adjusted.

2. The photographing method according to claim 1, wherein, the step of adjusting photosensitive parameters of at least one subarea comprises:
displaying all subareas of the photosensitive area;
selecting subareas, and acquiring required photosensitive parameters; and
adjusting photosensitive parameters of the selected subareas to the required photosensitive parameters acquired.

3. The photographing method according to claim 1, wherein, the step of adjusting photosensitive parameters of at least one subarea comprises:
displaying a preview image of a photographed scenery;
selecting an adjustment area on the preview image;
determining subareas of the photosensitive area corresponding to the adjustment area, and acquiring required photosensitive parameters; and
adjusting photosensitive parameters of the subareas corresponding to the adjustment area to the required photosensitive parameters acquired.

4. The photographing method according to claim 3, wherein after the step of adjusting photosensitive parameters of the subareas corresponding to the adjustment area to the required photosensitive parameters acquired, the method further comprises:
regenerating a preview image according to the adjusted photosensitive parameters and displaying the preview image.

5. The photographing method according to claim 1, wherein, the photosensitive parameters comprise: any one or more of exposure time, white balance and photosensibility.

6. A photographing device, comprising a processor and a memory, wherein
the memory is arranged to store instructions,
the processor is arranged to execute the instructions in the memory so as to divide a photosensitive area of a photosensitive element into at least two subareas,
adjust photosensitive parameters of at least one subarea; and
perform photographing according to photosensitive parameters of the at least two subareas of the photosensitive element after the photosensitive parameters are adjusted.

7. The photographing device according to claim 6, the processor is further arranged to
display all subareas of the photosensitive area;
adjust photosensitive parameters of at least one subarea by means of: selecting subareas, and acquiring required photosensitive parameters, and adjusting photosensitive parameters of the selected subareas to the required photosensitive parameters acquired.

8. The photographing device according to claim 6, the processor is further arranged to
generate a preview image of a photographed scenery;
display the preview image; and
adjust photosensitive parameters of at least one subarea by means of: selecting an adjustment area on the preview image; determining subareas of the photosensitive area corresponding to the adjustment area, and acquiring required photosensitive parameters; and adjusting photosensitive parameters of the subareas corresponding to the adjustment area to the required photosensitive parameters acquired.

9. The photographing device according to claim 8, wherein,
the processor is further arranged to
regenerate a preview image according to the adjusted photosensitive parameters;
display the regenerated preview image.

10. The photographing device according to claim 6, wherein, the photosensitive parameters comprise: any one or more of exposure time, white balance and photo sensibility.

11. The photographing device according to claim 6, further comprising a photosensitive element.

12. A computer memory medium storing a program instruction, which, when the program instruction is executed by a computer, enable the computer to execute a photographing method comprising:
dividing a photosensitive area of a photosensitive element into at least two subareas;
adjusting photosensitive parameters of at least one subarea; and
performing photographing according to photosensitive parameters of the at least two subareas of the photosensitive element after the photosensitive parameters are adjusted.

13. (canceled)

14. The computer memory medium according to claim 12, wherein, the step of adjusting photosensitive parameters of at least one subarea comprises:
displaying all subareas of the photosensitive area;
selecting subareas, and acquiring required photosensitive parameters; and
adjusting photosensitive parameters of the selected subareas to the required photosensitive parameters acquired.

15. The computer memory medium according to claim 12, wherein, the step of adjusting photosensitive parameters of at least one subarea comprises:
displaying a preview image of a photographed scenery;
selecting an adjustment area on the preview image;
determining subareas of the photosensitive area corresponding to the adjustment area, and acquiring required photosensitive parameters; and
adjusting photosensitive parameters of the subareas corresponding to the adjustment area to the required photosensitive parameters acquired.

16. The computer memory medium according to claim 15, wherein after the step of adjusting photosensitive parameters of the subareas corresponding to the adjustment area to the required photosensitive parameters acquired, the method further comprises:
regenerating a preview image according to the adjusted photosensitive parameters and displaying the preview image.

17. The computer memory medium according to claim 12, wherein, the photosensitive parameters comprise: any one or more of exposure time, white balance and photo sensibility.

18. The computer memory medium according to claim 12, wherein, after the step of dividing a photosensitive area of a photosensitive element into at least two subareas, further comprising:
implementting custom settings on the photosensitive parameters of each subarea respectively.

19. The photographing method according to claim 1, wherein after the step of dividing a photosensitive area of a photosensitive element into at least two subareas, further comprising:
implementting custom settings on the photosensitive parameters of each subarea respectively.

20. The photographing device according to claim 6, the processor is further arranged to implement custom settings on the photosensitive parameters of each subarea respectively after dividing a photosensitive area of a photosensitive element into at least two subareas.

21. The photographing device according to claim 2, wherein, the photosensitive parameters comprise: any one or more of exposure time, white balance and photo sensibility.
